(19) United States
(12) Patent Application Publication
(10) Pub. No.: US 2011/0074548 A1
(43) Pub. Date: Mar. 31, 2011

(54) ELECTRONIC APPARATUS AND ELECTRONIC APPARATUS SYSTEM

(76) Inventor: Akira Miyazawa, Honjo-shi (JP)

(21) Appl. No.: 12/823,695

(22) Filed: Jun. 25, 2010

(30) Foreign Application Priority Data
Sep. 25, 2009 (JP) 2009-221052

(51) Int. Cl. G08B 25/00; G05B 19/02

(52) U.S. Cl. 340/8.1; 340/12.54; 340/539.32

(57) ABSTRACT

According to an aspect of the present invention, there is provided an electronic apparatus including: a storage portion configured to store identifiers of a plurality of remote controllers; a transmitting portion configured to transmit a signal to an outside; and a control portion configured to: receive a request for calling a specific one of the remote controllers; obtain a specific one of the identifiers corresponding to the specific remote controller from the storage portion; and control the transmitting portion to transmit a call request signal based on the obtained specific identifier, the call request signal instructing the specific remote controller to perform a calling operation.

### CROSS-REFERENCE TO RELATED APPLICATIONS

This application is based upon and claims the benefit of priority from Japanese Patent Application No. 2009-221052, filed on Sep. 25, 2009, the entire contents of which are incorporated herein by reference.

### BACKGROUND

1. Field

An aspect of the present invention relates to an electronic apparatus and an electronic apparatus system.

2. Description of the Related Art

Some apparatus is capable of, when a remote controller is missed or misplaced, causing the remote controller to sound an alarm in response to a call request, so that the user can know the location of the remote controller (for example, JP-2002-345054-A).

The electronic apparatus disclosed in JP-2002-345054-A (such as a television receiver or a DVD (Digital Versatile Disc) player) has a remote controller therefor. The remote controller has: a storage portion which stores an ID for identifying itself; a receiving portion which receives a signal such as a radio signal or an optical signal from the electronic apparatus; a speaker which gives an alarm such as a buzzer sound in order to allow the user to know the location; and a control portion which causes the speaker to give an alarm when the call request signal designated with the stored ID is received. Therefore, when the user operates the electronic apparatus so as to issue a call request for the target remote controller, the user can know the location thereof.

In the above-described electronic apparatus, while the attached remote controller can be called, calling cannot be performed while designating another remote controller. Since a calling operation must be performed on an electronic apparatus corresponding to the other remote controller in order to call the other remote controller, the procedure of knowing the location of a remote controller is cumbersome.

### BRIEF DESCRIPTION OF THE DRAWINGS

A general architecture that implements the various feature of the present invention will now be described with reference to the drawings. The drawings and the associated descriptions are provided to illustrate embodiments of the present invention and not to limit the scope of the present invention.

FIG. 1 illustrates an example video display apparatus in an embodiment.

FIG. 2 illustrates an example block configuration of a control system of the video display apparatus.

FIG. 3 illustrates an example remote controller.

FIG. 4 illustrates an example block configuration of a control system of the remote controller.

FIG. 5 illustrates example call information.

FIG. 6 illustrates an example displayed content on a display portion.

FIG. 7 illustrates an example operation of the video display apparatus.

FIG. 8 illustrates an example operation of the remote controller.

### DETAILED DESCRIPTION

Various embodiments according to the present invention will be described hereinafter with reference to the accompanying drawings. In general, according to one embodiment of the present invention, there is provided an electronic apparatus including: a storage portion configured to store identifiers of a plurality of remote controllers; a transmitting portion configured to transmit a signal to an outside; and a control portion configured to: receive a request for calling a specific one of the remote controllers; obtain a specific one of the identifiers corresponding to the specific remote controller from the storage portion; and control the transmitting portion to transmit a call request signal based on the obtained specific identifier, the call request signal instructing the specific remote controller to perform a calling operation.

(Configuration of Video Display Apparatus)

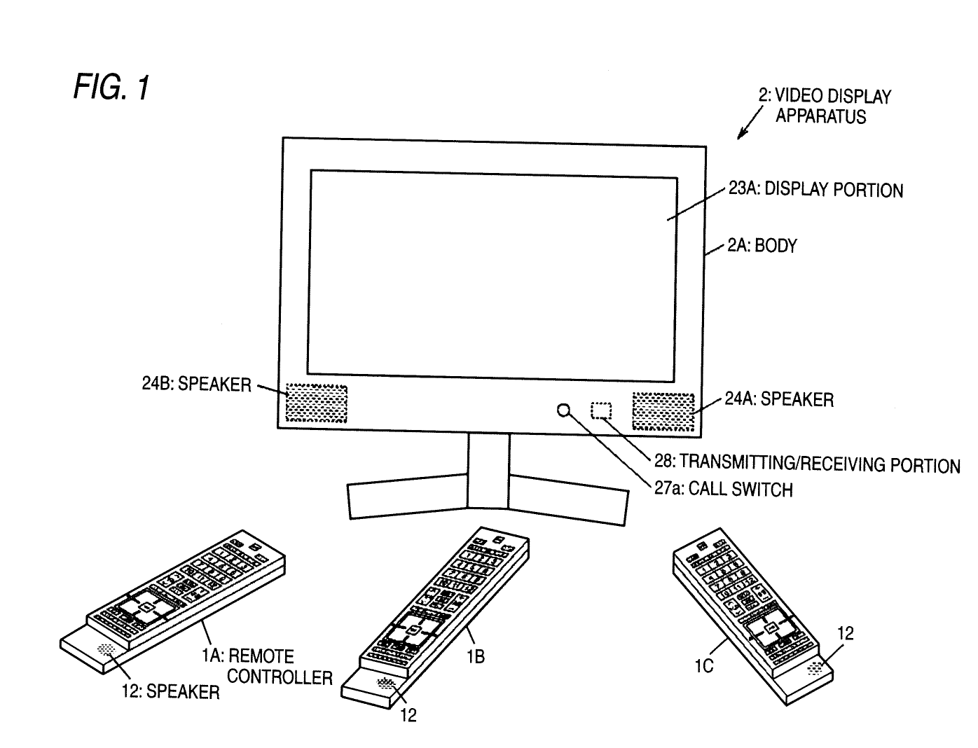

FIG. 1 illustrates an example video display apparatus in an embodiment.

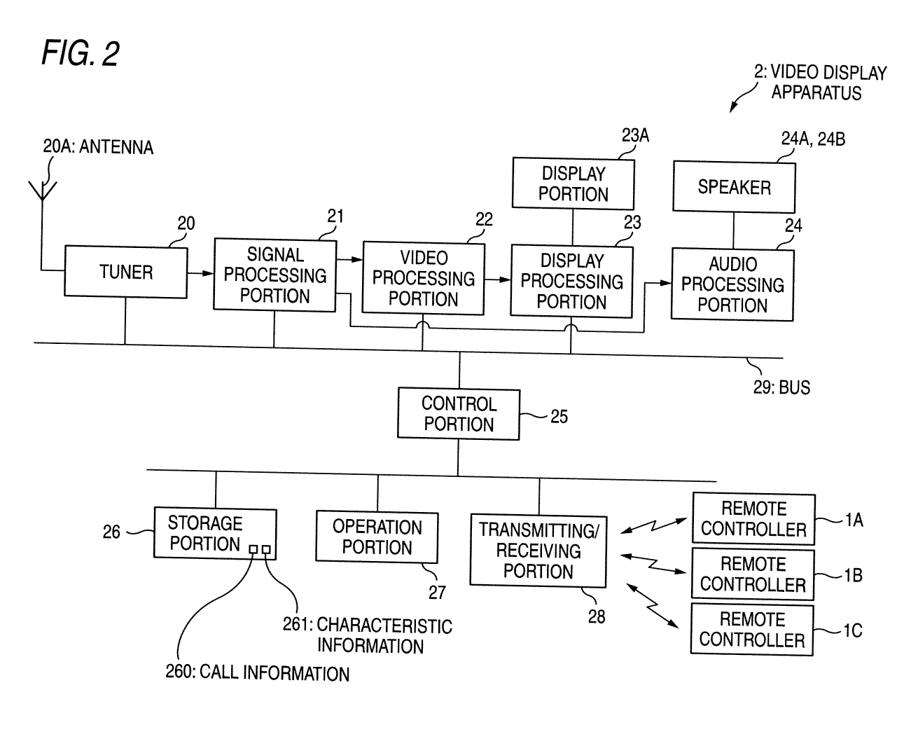

The video display apparatus 2 is a television receiver or the like which externally receives a digital broadcast wave or the like through an antenna (FIG. 2, 20A) to display a video image, or receives a video signal from an external video reproduction apparatus (not shown) such as an HDD (Hard Disc Drive) recorder or a DVD (Digital Versatile Disc) player to display a video image. The video display apparatus has: a display portion 23A configured by an LCD (Liquid Crystal Display) panel or the like in which a video image is displayed on the front face; speakers 24A, 24B which output a sound; a call switch 27a for calling plural remote controllers 1A to 1C having plural operation switches; and a transmitting/receiving portion 28 which transmits a call request signal using an RF (Radio Frequency) signal to the remote controllers 1A to 1C, and which receives an operation signal using an RF signal transmitted from the remote controllers 1A to 1C.

The video display apparatus 2 has, on the back face, an antenna terminal, external input terminals, operation portions configured by plural switches, and the like which are not shown, and, inside the body 2A, electronic components such as a CPU (Central Processing Unit) which processes the video signal and an audio signal, and which controls various portions, a RAM (Random Access Memory), a ROM (Read Only Memory), an HDD, etc.

Each of the remote controllers 1A to 1C has a speaker 12, and, when receiving a call request from the video display apparatus 2, emits an alarm such as a melody from the speaker 2. The remote controllers 1A to 1C are previously registered in the video display apparatus 2 by performing a pairing process or the like, and recognize identifiers by which the remote controllers 1A to 1C and the video display apparatus 2 are identified one another.

For example, the pairing process is performed by the user in accordance with a remote controller registration screen displayed on the display portion 23A. When a remote controller is not registered in the video display apparatus 2, the remote controller registration screen is automatically displayed on the display portion 23A. Also when a remote controller which has been registered is deleted and in the unregistered state, the same is performed. Alternatively, the remote controller registration screen may be displayed by operating an operation portion (not shown) or call switch 27a of the video display apparatus 2.

Although three remote controllers are shown in the figure, a single or plural remote controllers may be used. The remote controllers 1A to 1C are not restricted to remote controllers dedicated to the video display apparatus 2, and may be electronic devices such as a portable telephone or a PDA (Personal Digital Assistant) which has a remote control function.

FIG. 2 illustrates an example block configuration of the video display apparatus 2.

The video display apparatus 2 has a tuner 20, a signal processing portion 21, a video processing portion 22, a display processing portion 23, an audio processing portion 24, a control portion 25, a storage portion 26, an operation portion 27, and the transmitting/receiving portion 28. These portions are connected to one another through a bus 29.

The tuner 20 includes the antenna 20A which receives a broadcast signal transmitted from a digital broadcast station, selects a signal of a desired channel from the received broadcast signal, and transmits the selected signal to the signal processing portion 21.

The signal processing portion 21 is connected to the video processing portion 22 and the audio processing portion 24, separates the broadcast signal received from the tuner 20 to an audio signal and a video signal, supplies the video signal to the video processing portion 22, and supplies the audio signal to the audio processing portion 24.

The video processing portion 22 is connected to the display portion 23A through the display processing portion 23.

The display processing portion 23 performs an image quality adjustment on the input video signal, and supplies the video signal in which the image quality is adjusted, to the display portion 23A. The display processing portion 23 has a backlight processing portion, color temperature processing portion, and the like which are not shown, and which adjust the display of the display portion 23A. The display portion 23A has a backlight which is controlled by an inverter or the like to make the luminance variable, and the LCD panel which is illuminated by the backlight to display a video image. The backlight processing portion changes the luminance value of the backlight to adjust the brightness. The color temperature processing portion changes the gamma set value of the LCD panel to adjust the color temperature.

The audio processing portion 24 is connected to the speakers 24A, 24B. The audio processing portion 24 performs a sound quality adjustment on the input audio signal.

The video display apparatus 2 further has a video analog/digital converter (A/D) and audio A/D which receive video and audio signals transmitted from a video reproduction apparatus that is connected to an external input terminal (not shown). The video and audio signals which are input to the video A/D and the audio A/D are converted from an analog signal to a digital signal, and the output signals therefrom are supplied to the video processing portion 22 and the audio processing portion 24, respectively.

The control portion 25 has a CPU, and controls the various portions of the video display apparatus 2 through control lines such as the bus 29 which are indicated by the un-arrowed solid lines in FIG. 2.

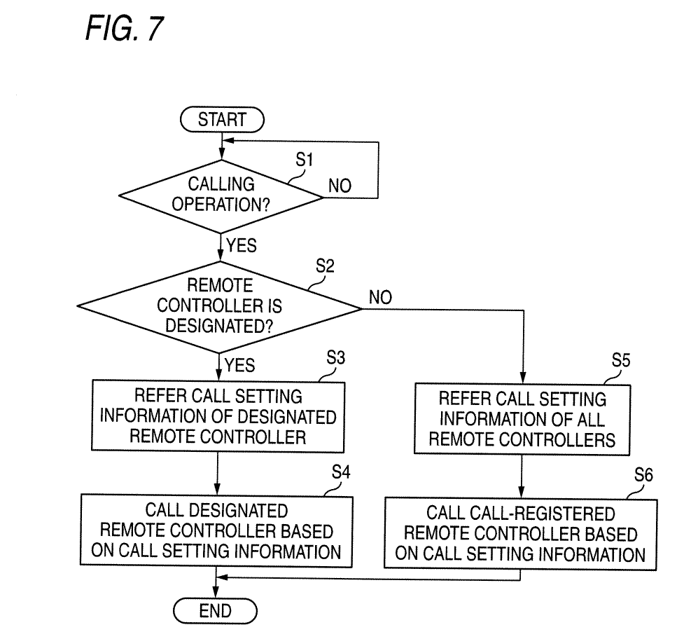

The storage portion 26 stores call setting information 260 which describes setting information and the like for calling the remote controllers 1A to 1C, characteristic information 261 indicating characteristics such as call sounds and vibration patterns of the remote controllers 1A to 1C which are obtained in registration (pairing) of the remote controllers 1A to 1C to the video display apparatus 2, video information of a program recorded by the video display apparatus 2, programs such as shown in FIG. 7 operating on the control portion 25, and the like.

The operation portion 27 includes a plurality of switches including the call switch 27a shown in FIG. 1, and, when the switches are operated by the user, supplies a signal for controlling the operation of the video display apparatus 2, to the control portion 25.

The transmitting/receiving portion 28 transmits RF signals to the remote controllers 1A to 1C, receives RF signals such as an operation signal from the remote controllers 1A to 1C, and supplies the signals to the control portion 25.

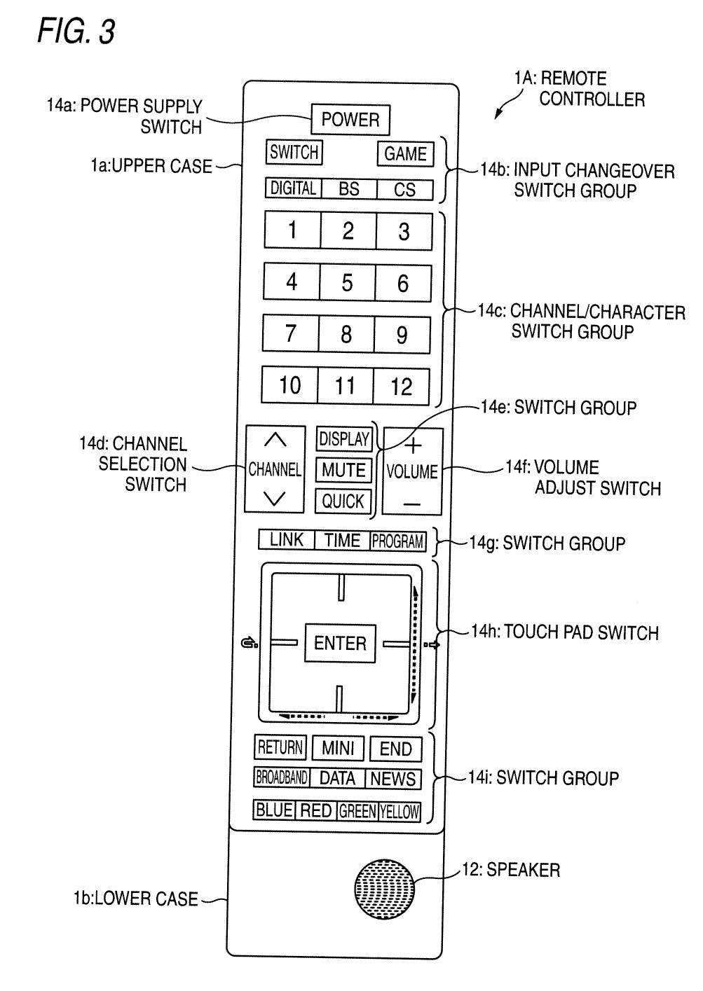

FIG. 3 exemplarily illustrates the remote controller 1A. The remote controllers 1B, 1C have the same configuration as that of the remote controller 1A, and hence the remote controller 1A will be representatively described.

The remote controller 1A is configured by an upper case 1a and a lower case 1b, and has a plurality of switches for operating the functions of the video display apparatus 2. The remote controller has: a power supply switch 14a which switches over the power-ON state and the power-OFF state of the video display apparatus 2; an input changeover switch group 14b including an input changeover switch which switches over the source of video information to be displayed, and switches which select a game, a terrestrial digital broadcast, a BS broadcast, or a CS broadcast; a channel/character switch group 14c which performs selection of the channel, input of characters, and the like; a channel selection switch 14d which switches the channel; a switch group 14e including a screen display switch which selects the display format of the screen, a mute switch, a quick switch, and the like; a volume adjust switch 14f which adjusts the sound volume; a switch group 14g including a link switch which causes an external apparatus to link with the video display apparatus 2, a time switch for displaying a past program list, a program list switch for displaying a program list, and the like; a touch pad switch 14h which has both the function of a touch pad and that of a press switch; a switch group 14i which includes a return switch, a mini-program list switch, an end switch, a broadband switch, a d-data switch, a news switch, color switches; and the speaker 12 which outputs an alarm such as a melody corresponding to a call request.

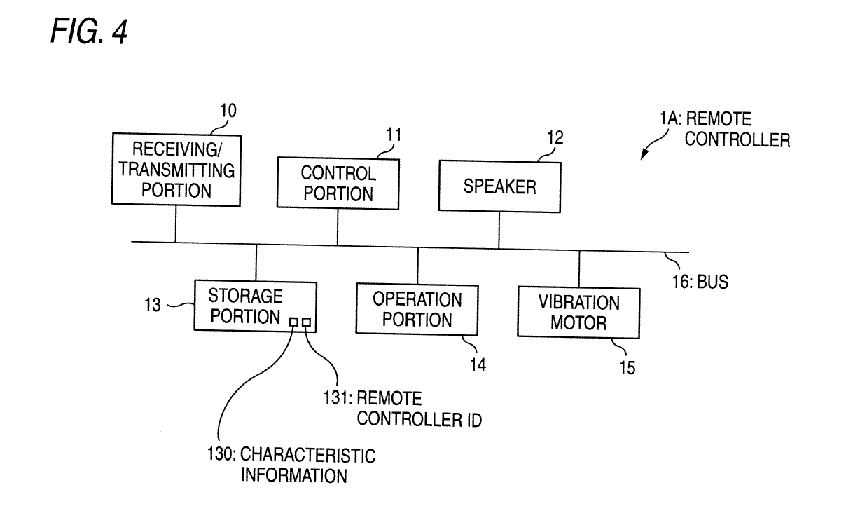

FIG. 4 illustrates an example block configuration of the remote controller 1A.

The remote controller 1A has a receiving/transmitting portion 10, a control portion 11, the speaker 12, a storage portion 13, an operation portion 14, and a vibration motor 15. These portions are connected to one another through a bus 16.

The receiving/transmitting portion 10 receives RF signals such as the call request from the video display apparatus 2, supplies the signals to the control portion 11, and, under the control of the control portion 11, transmits RF signals such as the operation signals to the video display apparatus 2.

The control portion 11 has a CPU, and controls the various portions through control lines such as the bus 16 which are indicated by the solid lines.

The speaker 12 outputs an alarm such as a melody under the control of the control portion 11.

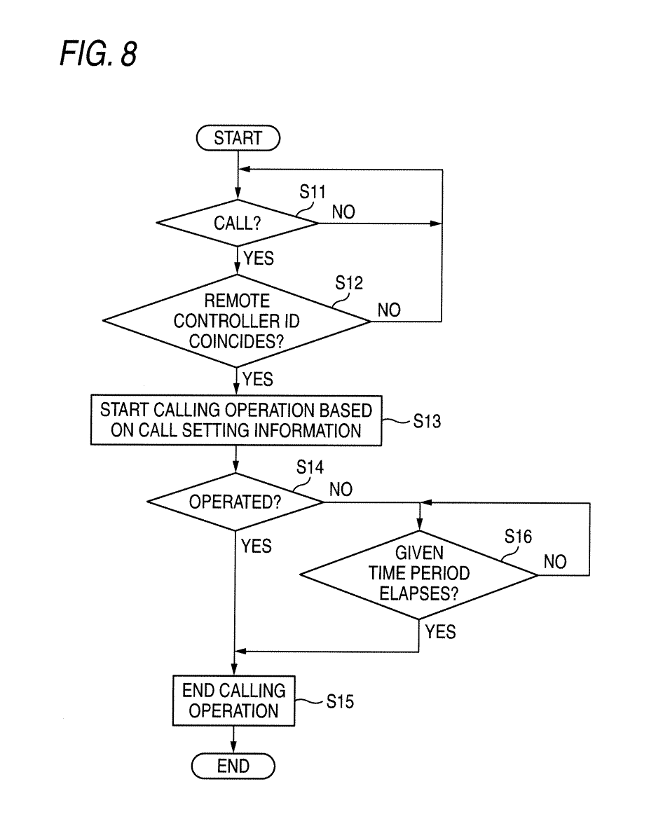

The storage portion 13 stores: characteristic information 130 indicating characteristics which can be performed in the remote controller 1A, such as a call sound pattern which is reproduced in the control portion 11 to be output as an alarm from the speaker 12, and a vibration pattern of vibrations which are produced in the vibration motor 15; a remote controller ID 131 which is identification information for identifying the remote controller 1A; information which correlates signals output from the operation portion 14 with the operation signals; programs such as shown in FIG. 8 which operate on the control portion 11; and the like.

The operation portion 14 includes the plural switches shown in FIG. 3, and, when the switches are operated by the user, supplies signals to the control portion 11.

The vibration motor 15 is operated by the control of the control portion 11 in response to the call request or the like, to vibrate the remote controller 1A.

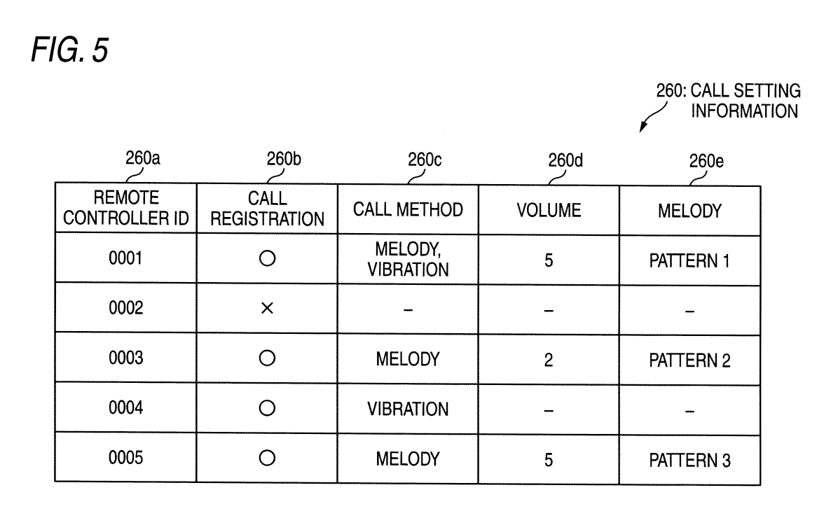

FIG. 5 exemplarily illustrates the call setting information 260.

The call setting information 260 has: a remote controller ID column 260a which indicates an identifier of a remote controller; a call registration column 260b which indicates whether a calling operation is to be performed or not when the call switch 27a is pressed; a call method column 260c which indicates the call method such as a melody or vibration; a volume column 260d which indicates the sound volume of a melody; and a melody column 260e which indicates the kind of the melody. The information described in the call method column 260c, the volume column 260d and the melody column 260e are selected in a call setting screen 230, based on the characteristic information 261 which is received from the remote controllers 1A to 1C when the remote controllers 1A to 1C are registered in the video display apparatus 2.

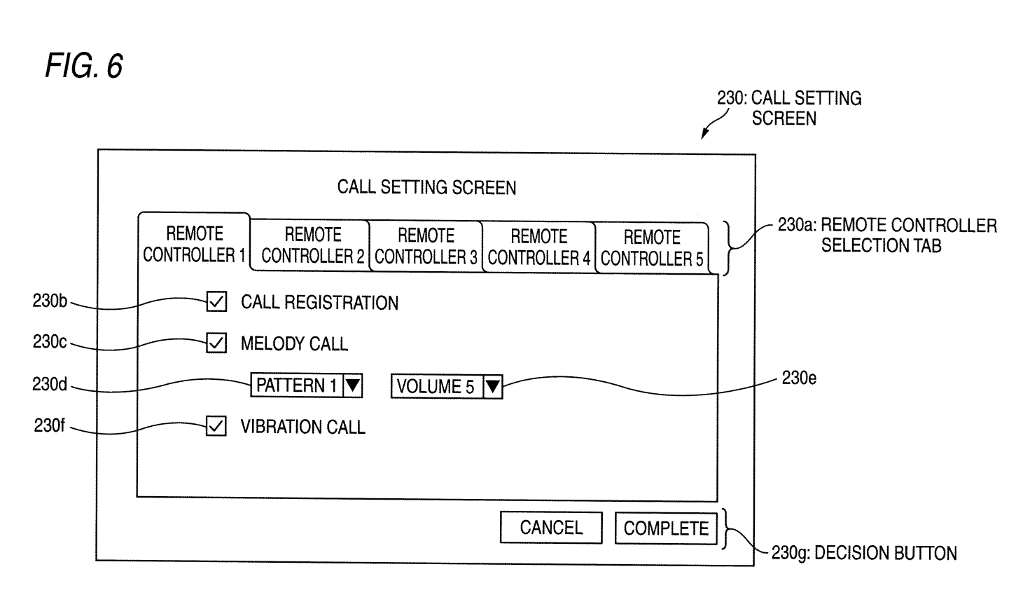

FIG. 6 exemplarily illustrates the displayed content on the display portion 23A.

The call setting screen 230 is displayed, on the display portion 23A, to set the call setting information 260 for designating the call method and the like for the remote controllers 1A to 1C. The call setting screen 230 includes a remote controller selection tab 230a, a call registration check box 230b, a melody call check box 230c, a melody pattern menu 230d and volume selection menu 230e, a vibration call check box 230f and a decision button 230g. Through the remote controller selection tab 230a, a remote controller in which the call setting information 260 is to be set is selected. When the call registration check box 230b is checked, the calling operation is performed in the selected remote controller. When the melody call check box 230c is checked, the calling operation by using a melody is performed. Through the melody pattern menu 230d and volume selection menu 230e, a melody pattern and a calling volume are selected. When the vibration call check box 230f is checked, the calling operation by using a vibration is performed. And, by pressing the decision button 230g, the settings in the call setting screen 230 are determined.

Each of the melody call check box 230c, the melody pattern menu 230d, the volume selection menu 230e, and the vibration call check box 230f may not displayed for each of remote controllers 1A to 1C according to the characteristic information 261 thereof. In the melody pattern menu 230d and the volume selection menu 230e, the displayed menu may be differentiated for each of remote controllers 1A to 1C according to the characteristic information 261 thereof.

(Operation of Video Display Apparatus)

Hereinafter, an operation example of the video display apparatus in the embodiment will be described with reference to the figures.

In order to turn ON the power supply of the video display apparatus 2, first, the user presses the power supply switch 14a of the remote controller 1A. When the power supply switch 14a is pressed, the control portion 11 of the remote controller 1A produces an operation signal for turning ON the power supply of the video display apparatus 2. Next, the receiving/transmitting portion 10 transmits the produced operation signal to the video display apparatus 2 by means of an RF signal.

When the transmitting/receiving portion 28 of the video display apparatus 2 receives the RF signal, the portion supplies an operation signal to the control portion 25, and, based on the received operation signal, the control portion 25 requests a power supplying portion (not shown) to turn ON the power supply of the video display apparatus 2. The above-described operations are performed also when another switch of the operation portion 14 is pressed.

When the user wishes to perform the call setting on one of the remote controllers 1A to 1C, the user operates, for example, the remote controller 1A to request the call setting screen 230 shown in FIG. 6 to be displayed on the display portion 23A of the video display apparatus 2. In response to the request, the control portion 25 of the video display apparatus 2 displays the call setting screen 230 on the display portion 23A, and, in accordance with the displayed contents, the user operates the remote controller 1A.

When the user presses the decision button 230g to end the call setting in the call setting screen 230, the control portion 25 stores the settings in the call setting screen 230 into the call setting information 260 of the storage portion 26. Alternatively, the operations in the call setting screen 230 may be performed through the operation portion 27 of the video display apparatus 2.

FIG. 7 illustrates an example operation of the video display apparatus 2.

First, the user operates the call switch 27a of the operation portion 27 (S1: Yes). If the operation designates, for example, the remote controller 1A as a calling subject (S2: Yes), the control portion 25 refers the information relating to the remote controller 1A in the call setting information 260, i.e., information corresponding to remote controller ID “0001” shown in FIG. 5 (S3). Next, the control portion 25 transmits the call signal through the transmitting/receiving portion 28 based on the information of remote controller ID “0001” in the call setting information 260, and performs the calling operation (S4). In step S2, the remote controller is designated by, for example, the number of operations of pressing the call switch 27a, and identification information and the like of the remote controller to be designated is displayed on the display portion 23A.

If a remote controller is not designated in step S2 (S2: No), the control portion 25 refers information of all of the remote controllers in the call setting information 260 (S5), transmits the call signal through the transmitting/receiving portion 28 based on the information of the respective remote controllers in the call setting information 260, and performs the calling operation (S6). Namely, the control portion performs the process of calling remote controller IDs “0001”, “0003”, “0004”, and “0005”. For example, the calling of all of the remote controllers in step S2 is designated by pressing the call switch 27a for a long time period (several seconds).

FIG. 8 illustrates an example operation of the remote controller 1A. The remote controllers 1A to 1C operate in the same manner, and hence the remote controller 1A will be representatively described.

First, when the receiving/transmitting portion 10 of the remote controller 1A receives the call signal (S11), the control portion 11 checks whether the call signal contains information coincident with the remote controller ID 131 or not. If such information is contained (S12: Yes), a calling operation is performed based on the call method, volume, melody, and the like which are set in remote controller ID “0001” in the call setting information 260 (S13). Namely, in accordance with the characteristic information 130 in the storage portion 13, the melody of melody pattern 1 is reproduced at a volume of 5 from the speaker 12, and the vibration motor 15 is operated.

Next, when the remote controller 1A is found by the user and any operation is performed on the remote controller 1A (S14: Yes), or when no operation is performed (S14: No) and a given time period elapses (S16: Yes), the control portion 11 ends the calling operation (S15). Alternatively, when the operation portion 27 of the video display apparatus 2 is operated, the calling operation may be ended.

### EFFECTS OF EMBODIMENT

According to the above-described embodiment, plural remote controllers can be previously registered as calling subjects in the call setting information 260, and the desired remote controller can be designated by an operation of pressing the call switch 27a. Therefore, calling of plural remote controllers can be easily performed by using only the video display apparatus 2.

The call method, volume, melody, and the like can be set respectively for each remote controller in the video display apparatus 2 by using the call setting screen 230. Therefore, the operation can be performed easily as compared with the case where the setting is performed in each remote controller. The setting can be differentiated for each remote controller. When plural remote controllers are simultaneously called, therefore, the user can easily recognize the locations of the plural remote controllers.

### Other Embodiments

The invention is not restricted to the above-described embodiment, and can be variously modified without departing the spirit of the invention. For example, an RF signal is used in communications between the remote controllers 1A to 1C and the video display apparatus 2. As a method of transmitting an RF signal, a communication method of an omni-directional standard such as IEEE 802.15.4 or low-power Bluetooth may be used, or another standard may be used as far as the communication is omni-directionally performed. Although an omni-directional communication method is preferred, a directional communication method such as infrared communication may be used.

When only one remote controller is registered in the video display apparatus 2, for example, default settings may be used without the user's operation through the call setting screen 230 so that the call registration and the melody call are always ON.

Illuminance sensors or the like may be further disposed in the remote controllers 1A to 1C, respectively, and the call volume may be changed in accordance with the illuminance. According to the configuration, even if the remote controllers 1A to 1C are left behind things and the alarm sound hardly reaches the user, for example, the volume may be automatically increased (set to the maximum value), so that the user can know the location.

There may be configured such that the characteristic information 130 is downloaded from the video display apparatus 2 by an RF signal. The characteristic information 130 may be downloaded from an Internet through wired/wireless communication. This may be applicable also to the vibration pattern of the vibration motor 15.

In the case where the maximum registration number of remote controllers in the video display apparatus 2 is preset and the registration is performed while exceeding the maximum number, the video display apparatus 2 may delete the registration of the oldest registered remote controller. When the registration of a remote controller which has been already registered is requested, a message indicating that the remote controller has been already registered may be displayed on the display portion 23A. When the registration is further requested in spite of the message, information that has been already registered may be overwritten.

According to an aspect of the invention, the user can know the location of a remote controller and can call a specific remote controller in an easy manner.

What is claimed is:

1. An electronic apparatus comprising:
a storage portion configured to store identifiers of a plurality of remote controllers;
a transmitting portion configured to transmit a signal to an outside; and
a control portion configured to:
receive a request for calling a specific one of the remote controllers;
obtain a specific one of the identifiers corresponding to the specific remote controller from the storage portion; and
control the transmitting portion to transmit a call request signal based on the obtained specific identifier, the call request signal instructing the specific remote controller to perform a calling operation.

2. The apparatus of claim 1,
wherein the storage portion stores characteristic information indicating characteristics of the remote controllers correspondingly with the identifiers, respectively, and
wherein the control portion:
receives a request for setting call setting information for a specific remote controller;
set the call setting information for the specific remote controller based on the characteristic information thereof; and
controls the storage portion to store the call setting information for the specific remote controller correspondingly with the identifier thereof.

3. Apparatus of claim 2,
wherein the control portion controls the transmitting portion to transmit the call request signal based on the identifier and on the call setting information.

4. An electronic apparatus system comprising:
an apparatus body including:
a first storage portion configured to store identifiers of a plurality of remote controllers;
a transmitting portion configured to transmit a signal to an outside; and
a first control portion configured to
receive a request for calling a specific one of the remote controllers;
obtain a specific one of the identifiers corresponding to the specific remote controller from the first storage portion; and
control the transmitting portion to transmit a call request signal based on the obtained specific identifier; and
a remote controller configured to remotely control the apparatus body, the remote controller having:
a second storage portion configured to store an identifier identifying itself and characteristic information indicating characteristics thereof;
a speaker configured to output a sound;
a receiving portion configured to receive the call request signal transmitted from the apparatus body; and
a second control portion configured to:
determine whether the received call request signal includes the identifier stored in the second storage portion;
generate a call sound based on the characteristic information stored in the second storage portion; and
controls the speaker to output the call sound.

5. An electronic apparatus including:
a storage portion configured to store an identifier and characteristic information of a remote controller; and
a control portion configured to:
set call setting information for the specific remote controller based on the characteristic information; and
instruct, upon a request for calling the remote controller, the remote controller to perform a calling operation based on the identifier and the call setting information.
